(19) United States
(12) Patent Application Publication
(10) Pub. No.: US 2026/0109358 A1
(43) Pub. Date: Apr. 23, 2026

(54) MOTION CONTROL SYSTEM DETERMINING A LONGITUDINAL ACCELERATION COMMAND FOR A VEHICLE

(71) Applicant: GM Global Technology Operations LLC, Detroit, MI (US)

(72) Inventors: Kevin A. O'Dea, Ann Arbor, MI (US); Scott Andrusiak, West Bloomfield, MI (US); Chase Goodin, Howell, MI (US)

(21) Appl. No.: 18/921,775

(22) Filed: Oct. 21, 2024

(51) Int. Cl. B60W 50/00; B60W 30/14; B60W 50/02; B60W 50/06; B60W 60/00

(52) U.S. Cl. CPC B60W 50/0097; B60W 30/146; B60W 50/0205; B60W 50/06; B60W 60/001; B60W 2520/105; B60W 2520/12; B60W 2520/14; B60W 2530/10; B60W 2530/203

(57) ABSTRACT

A motion control system for a vehicle includes one or more controllers. The one or more controllers include one or more processors that execute instructions to receive a current longitudinal vehicle velocity and an autonomous acceleration command, determine a predicted longitudinal velocity of the vehicle based on the current longitudinal vehicle velocity and the autonomous acceleration command, and determine a predicted lateral acceleration of the vehicle based on the predicted longitudinal velocity of the vehicle and determine an allowed longitudinal acceleration of the vehicle based on the predicted lateral acceleration of the vehicle and the current longitudinal vehicle velocity. The one or more controllers determine a longitudinal acceleration command based on the allowed longitudinal acceleration and the current longitudinal vehicle velocity and instruct the prime mover of the vehicle to limit the speed of the vehicle based on the longitudinal acceleration command.

### INTRODUCTION

The present disclosure relates to a motion control system that limits the speed of a vehicle based on a longitudinal acceleration command as the vehicle negotiates a curve along a roadway. The motion control system determines the longitudinal acceleration command based on a predicted lateral acceleration.

Many vehicles today are equipped with motion control systems for enhancing driver control. For example, adaptive cruise control (ACC) is an advanced driver assistance system (ADAS) that relieves drivers from routine longitudinal vehicle control by ensuring an ego vehicle is an acceptable headway distance from a vehicle that immediately precedes the ego vehicle. Motion control systems, such as an adaptive cruise control system, maintain a set vehicle speed that may be preselected by a driver. However, sometimes the set vehicle speed may be too high to negotiate a curve in a roadway while still maintaining occupant comfort as defined by the value of the lateral acceleration limit. The lateral acceleration limit is a calibration value, and its typical value is usually about three meters per second squared.

Thus, while current motion control systems achieve their intended purpose, there is a need in the art for an improved approach for negotiating a curve along the roadway that maintains occupant comfort.

### SUMMARY

According to several aspects, a motion control system for a vehicle including a prime mover is disclosed. The motion control system includes one or more controllers in electronic communication with the prime mover. The one or more controllers include one or more processors that execute instructions to receive a current longitudinal vehicle velocity and an autonomous acceleration command and determine a predicted longitudinal velocity of the vehicle based on the current longitudinal vehicle velocity and the autonomous acceleration command. The one or more controllers determine a predicted lateral acceleration of the vehicle based on the predicted longitudinal velocity of the vehicle and determine an allowed longitudinal acceleration of the vehicle based on the predicted lateral acceleration of the vehicle and the current longitudinal vehicle velocity. The one or more controllers determine a longitudinal acceleration command based on the allowed longitudinal acceleration and the current longitudinal vehicle velocity and instruct the prime mover of the vehicle to limit the speed of the vehicle based on the longitudinal acceleration command.

In another aspect, the one or more controllers determine the longitudinal acceleration command as:

$${A}_{xC} = {K}_{i} \int {A}_{xERR} + {K}_{P 1} {A}_{xERR} + min ( {K}_{P 2} {V}_{xERR} , {A}_{xA} )$$

where A_{xC} represents the longitudinal acceleration command, Kᵢ represents a control gain of an integration error, A_{xERR} represents an acceleration-based error term, K_{P1} represents a first proportional control gain, K_{P2} represents a proportional gain, A_{xA} represents the allowed longitudinal acceleration, and V_{xERR} represents a velocity-based error term.

In yet another aspect, the longitudinal acceleration command of the vehicle includes an acceleration-based error component that is based on an acceleration-based error term and a velocity-based error component that is based on a velocity-based error term.

In an aspect, the one or more controllers limit the velocity-based error component of the longitudinal acceleration command of the vehicle.

In another aspect, the one or more controllers determine the longitudinal acceleration command based on a two-dimensional look-up table.

In yet another aspect, determining the predicted lateral acceleration of the vehicle includes determining a predicted yaw rate of the vehicle based on the predicted longitudinal velocity of the vehicle, and multiplying the predicted yaw rate of the vehicle with the current longitudinal vehicle velocity, wherein the derivative of a current lateral vehicle velocity is assumed to be zero.

In an aspect, the predicted yaw rate is determined as:

$$ψ = \frac{δ * {V}_{xP}}{L + {K}_{us} * {V}_{xP}^{2}}$$

where \dot{ψ} represents the predicted yaw rate, δ represents a predicted road wheel angle of the vehicle, L represents the wheelbase of the vehicle, Kᵤₛ represents an understeer coefficient, and V_{xP} represents the predicted longitudinal velocity.

In an aspect, the understeer coefficient accounts for vehicle weight as well as the presence of a trailer.

In another aspect, the one or more controllers determine the allowed longitudinal acceleration of the vehicle based on a two-dimensional look-up table that provides the allowed longitudinal acceleration of the vehicle based on the predicted lateral acceleration and the current longitudinal vehicle velocity.

In yet another aspect, the one or more controllers determine the allowed longitudinal acceleration of the vehicle as:

$${A}_{xA} = \sqrt{{K}_{vx} - {A}_{yP}^{2}}$$

where A_{xA} represents the allowed longitudinal acceleration of the vehicle, Kᵥₓ represents a velocity-based constant, and A_{yP} represents the predicted lateral acceleration.

In an aspect, the predicted longitudinal velocity is determined as:

$${V}_{xP} = {V}_{x} + {A}_{xC} {T}_{P}$$

where V_{xP} represents the predicted longitudinal velocity, Vₓ represents the current longitudinal vehicle velocity, A_{xC} represents the autonomous acceleration command A_{xC}, and T_{P} represents a predicted time.

In another aspect, the predicted time represents a calibration parameter determined based on a reaction time of a propulsion system of the vehicle.

In yet another aspect, the motion control system is an advanced driver assistance system (ADAS).

In an aspect, the motion control system is an adaptive cruise control system (ACC).

In another aspect, a method for limiting the speed of a vehicle by a motion control system. The method includes receiving, by one or more controllers, a current longitudinal vehicle velocity and an autonomous acceleration command. The method also includes determining, by the one or more controllers, a predicted longitudinal velocity of the vehicle based on the current longitudinal vehicle velocity and the autonomous acceleration command and determining a predicted lateral acceleration of the vehicle based on the predicted longitudinal velocity of the vehicle. The method also includes determining an allowed longitudinal acceleration of the vehicle based on the predicted lateral acceleration of the vehicle and the current longitudinal vehicle velocity and determining a longitudinal acceleration command based on the allowed longitudinal acceleration and the current longitudinal vehicle velocity. The method also includes instructing a prime mover of the vehicle to limit the speed of the vehicle based on the longitudinal acceleration command.

In yet another aspect, the method further comprises determining the longitudinal acceleration command as:

$${A}_{xC} = {K}_{i} \int {A}_{xERR} + {K}_{P 1} {A}_{xERR} + min ( {K}_{P 2} {V}_{xERR} , {A}_{xA} )$$

where A_{xC} represents the longitudinal acceleration command, Kᵢ represents a control gain of an integration error, A_{xERR} represents an acceleration-based error term, K_{P1} represents a first proportional control gain, K_{P2} represents a proportional gain, A_{xA} represents the allowed longitudinal acceleration, and V_{xERR} represents a velocity-based error term.

In an aspect, the method further comprises limiting a velocity-based error component of the longitudinal acceleration command of the vehicle.

In another aspect, the method further comprises determining the longitudinal acceleration command based on a two-dimensional look-up table.

In another aspect, the method further comprises determining the predicted lateral acceleration of the vehicle by determining a predicted yaw rate of the vehicle based on the predicted longitudinal velocity of the vehicle and multiplying the predicted yaw rate of the vehicle with the current longitudinal vehicle velocity, where the derivative of a current lateral vehicle velocity is assumed to be zero.

In yet another aspect, a motion control system for a vehicle including a prime mover is disclosed. The motion control system includes one or more controllers in electronic communication with the prime mover, where the one or more controllers include one or more processors that execute instructions to receive a current longitudinal vehicle velocity and an autonomous acceleration command. The one or more controllers determine a predicted longitudinal velocity of the vehicle based on the current longitudinal vehicle velocity and the autonomous acceleration command and determine a predicted lateral acceleration of the vehicle based on the predicted longitudinal velocity of the vehicle. The one or more controller determine an allowed longitudinal acceleration of the vehicle based on the predicted lateral acceleration of the vehicle and the current longitudinal vehicle velocity and determine a longitudinal acceleration command based on the allowed longitudinal acceleration and the current longitudinal vehicle velocity, wherein the longitudinal acceleration command of the vehicle includes an acceleration-based error component that is based on an acceleration-based error term and a velocity-based error component that is based on a velocity-based error term. The one or more controllers limit the velocity-based error component of the longitudinal acceleration command of the vehicle and instruct the prime mover of the vehicle to limit the speed of the vehicle based on the longitudinal acceleration command.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle including the disclosed motion control system having one or more controllers in electronic communication in electronic communication with a prime mover, according to an exemplary embodiment;

FIG. 2 is a diagram of the vehicle shown in FIG. 1 negotiating a curve, according to an exemplary embodiment; and

FIG. 3 is a process flow diagram illustrating a method for determining a longitudinal acceleration command for the vehicle shown in FIG. 1 based on a predicted lateral acceleration, according to an exemplary embodiment.

### DETAILED DESCRIPTION

The following description is merely exemplary in nature and is not intended to limit the present disclosure, application, or uses.

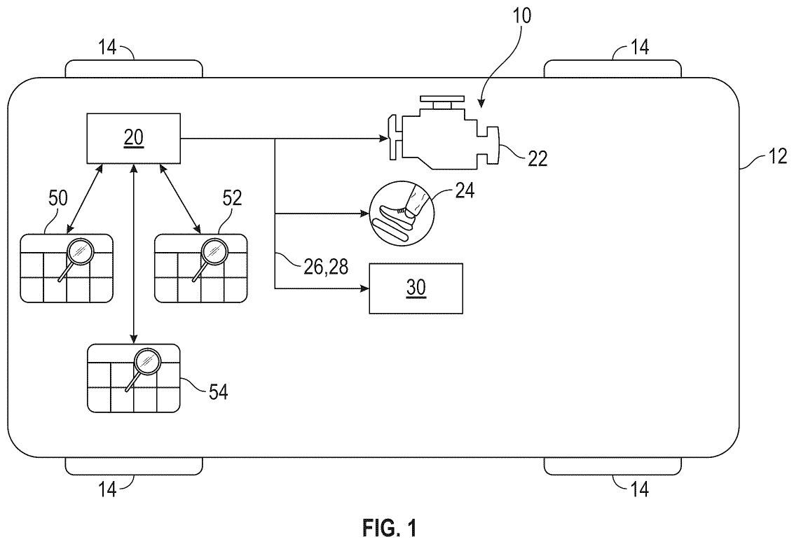

Referring to FIG. 1, a schematic diagram of an exemplary motion control system 10 for a vehicle 12 is illustrated. It is to be appreciated that the vehicle 12 may be any type of vehicle such as, but not limited to, a sedan, truck, sport utility vehicle, van, or motor home. In one embodiment, the motion control system 10 is part of semi-autonomous system that controls the speed of the vehicle 12 while a driver steers the vehicle 12 such as an advanced driver assistance system (ADAS). One specific example of an ADAS that controls the speed of the vehicle 12 is an adaptive cruise control system (ACC). Although semi-autonomous systems are described, it is to be appreciated that the motion control system 10 may also be a fully autonomous driving system such as automated driving systems (ADS) as well, however, instead of utilizing steering wheel input as generated by the driver, the motion control system 10 utilizes steering wheel input generated by the ADS instead.

The motion control system 10 of the vehicle 12 includes one or more controllers 20. In one embodiment, the one or more controllers 20 are proportional integral (PI) controllers. The one or more controllers 20 are in electronic communication with a prime mover 22 and a braking system 24. The prime mover 22 represents a source of power that propels the vehicle 12 and includes an internal combustion engine, one or more electric motors, or a combination of an internal combustion engine and one or more electric motors. The braking system 24 includes a set of brakes corresponding to each wheel 14 of the vehicle 12. The one or more controllers 20 also receive a plurality of sensor inputs 26 and a plurality of autonomous commands 28 from one or more systems 30 that are part of the vehicle 12. The plurality of sensor inputs 26 include a current longitudinal vehicle velocity Vₓ, a current lateral vehicle velocity V_{y}, and a road wheel angle. The plurality of autonomous commands 28 include an autonomous acceleration command A_{xC}.

As explained below, the one or more controllers 20 determine a predicted longitudinal velocity Vₓ, of the vehicle 12 based on the current longitudinal vehicle velocity Vₓ and the autonomous acceleration command A_{xC}. The one or more controllers 20 then determine a predicted lateral acceleration A_{yP} of the vehicle 12 based on the predicted longitudinal velocity V_{xP} of the vehicle 12 and a predicted yaw rate \dot{ψ} of the vehicle 12. The one or more controllers 20 then determine an allowed longitudinal acceleration A_{xA} of the vehicle 12 based on the current longitudinal vehicle velocity Vₓ and the predicted lateral acceleration A_{yP}. The one or more controllers 20 then determine a longitudinal acceleration command A_{xC} based on the allowed longitudinal acceleration A_{XA}. It is to be appreciated that the longitudinal acceleration command A_{xC} is determined by modeling the vehicle 12 based on the kinematic bicycle model.

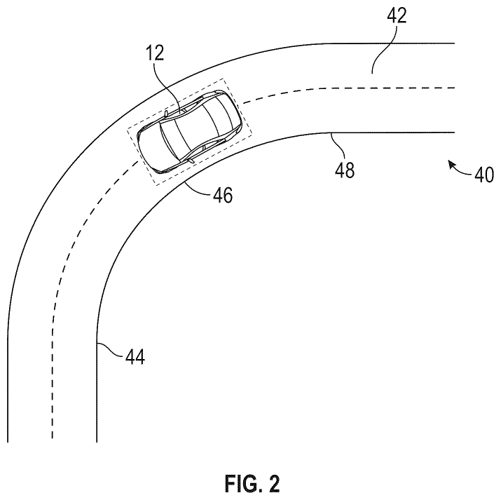

FIG. 2 is a diagram of the vehicle 12 negotiating a curve 40 located along a roadway 42. The one or more controllers 20 of the motion control system 10 instruct the prime mover 22 of the vehicle 12 to limit the speed of the vehicle 12 based on the longitudinal acceleration command A_{xC} as the vehicle 12 negotiates the curve 40 in the roadway 42 based on occupant comfort parameters. Specifically, the disclosed motion control system 10 reduces the longitudinal acceleration and thus the speed of the vehicle 12 as the vehicle 12 starts to enter the start 44 of the curve 40. Additionally, it is to be appreciated that the longitudinal acceleration command A_{xC} may be negative to further reduce the longitudinal velocity of the vehicle 12, which in turn improves control of the lateral acceleration. The negative longitudinal acceleration command A_{xC} may be accomplished by more than one actuator that is part of the vehicle 12, such as the prime mover 22 (i.e., a motor or engine) and the braking system 24. The motion control system 10 may then hold the longitudinal velocity of the vehicle 12 as the vehicle 12 travels around the curve 40 by a near zero longitudinal acceleration command Aₓc, and increases the longitudinal velocity by increasing the longitudinal acceleration command A_{xC} as the vehicle 12 approaches the end 48 of the curve 40. The longitudinal velocity of the vehicle 12 results in maintaining or satisfying occupant comfort parameters as the vehicle 12 negotiates the curve 40. The occupant comfort parameters are selected so as to reduce unwanted acceleration and jerk that occupant of the vehicle 12 may find objectionable as the vehicle 12 negotiates the curve 40. In one example, the occupant comfort parameters include an acceleration limit that is less than about 2 meters per second squared (m/s²) and a jerk limit that is less than about 0.2 meters per second cubed (m/s³), however, it is to be appreciated that the acceleration limit and the jerk limit are calibratable values. The longitudinal velocity of the vehicle 12 is controlled by limiting the longitudinal acceleration command Aₓc. Specifically, the value of the longitudinal acceleration command A_{xC} results in a negative longitudinal acceleration at the start 44 of the curve 40, zero longitudinal acceleration while traveling around the curve 40, and positive longitudinal acceleration at the end 48 of the curve.

Referring to FIG. 1, the one or more controllers 20 first determine the predicted longitudinal velocity V_{xP} of the vehicle 12 based on the current longitudinal vehicle velocity Vₓ, the autonomous acceleration command A_{xC}, and a predicted time T_{P}. The predicted time T_{P} represents a calibration parameter determined based on a reaction time of the propulsion system (i.e., the prime mover 22) of the vehicle 12, and is used to estimate the velocity of the vehicle 12 at some time in the future. In one embodiment, the predicted time T_{P} ranges from about 0.5 seconds to about 1 second, however, it is to be appreciated that other values may be used as well. Specifically, the predicted longitudinal velocity V_{xP} of the vehicle 12 is expressed in Equation 1 as:

$${V}_{xP} = {V}_{x} + {A}_{xC} {T}_{P} \qquad Equation 1$$

The one or more controllers 20 then determine the predicted lateral acceleration A_{yP} of the vehicle 12 based on the predicted longitudinal velocity Vₓ, of the vehicle 12. Specifically, the one or more controllers 20 determine the predicted lateral acceleration A_{yP} of the vehicle 12 by first determining the predicted yaw rate of the vehicle 12 based on the predicted longitudinal velocity V_{xP} of the vehicle 12, and then multiplying the predicted yaw rate of the vehicle 12 with the current longitudinal vehicle velocity Vₓ, or A_{yP}=*Vₓ. It is to be appreciated that the derivative of the current lateral vehicle velocity V_{y} is assumed to be zero, or V_{y}=0. Specifically, the predicted yaw rate p of the vehicle 12 is determined based on Equation 2, which is:

$$\dot{ψ} = \frac{δ * {V}_{xP}}{L + {K}_{us} * {V}_{xP}^{2}} \qquad Equation 2$$

where δ represents a predicted road wheel angle of the vehicle 12 and is the sum of the road wheel angle and the product of a time-based parameter K multiplied by a \dot{δ} derivative of the road wheel angle, or δ=road wheel angle+K*\dot{δ}, L represents the wheelbase of the vehicle 12, and Kᵤₛ represents an understeer coefficient. The time-based parameter K may range from about zero to about 0.5 seconds. It is to be appreciated that the understeer coefficient Kᵤₛ accounts for vehicle weight as well as the presence of a trailer.

The one or more controllers 20 may then determine the allowed longitudinal acceleration A_{xA} of the vehicle 12 based on the predicted lateral acceleration A_{yP} of the vehicle 12 and the current longitudinal vehicle velocity V₂. Specifically, in one non-limiting embodiment, the one or more controllers 20 determines the allowed longitudinal acceleration A_{xA} of the vehicle 12 based on a two-dimensional look-up table 50 that is either saved in memory or in a database in wireless communication with the one or more controllers 20. The two-dimensional look-up table 50 provides the allowed longitudinal acceleration A_{xA} of the vehicle 12 based on the predicted lateral acceleration A_{yP} of the vehicle 12 and the current longitudinal vehicle velocity Vₓ. Alternatively, in another embodiment, the allowed longitudinal acceleration A_{xA} of the vehicle 12 is the square root of a difference between a velocity-based constant Kᵥₓ and the predicted lateral acceleration A_{yP} squared, which is expressed in Equation 3 as:

$${A}_{xA} = \sqrt{{K}_{vx} - {A}_{yP}^{2}} \qquad Equation 3$$

where the velocity-based constant Kᵥₓ is a function of the current longitudinal vehicle velocity Vₓ. In one embodiment, the one or more controllers 20 may determine the velocity-based constant Kᵥₓ based on a one-dimensional look-up table 52 that is either saved in memory or is saved in a database that is in wireless communication with the one or more controllers 20.

The one or more controllers 20 then determine the longitudinal acceleration command A_{xC} based on the allowed longitudinal acceleration A_{xA} and the current longitudinal vehicle velocity Vₓ. The one or more controllers 20 may then instruct the prime mover 22 of the vehicle 12 to limit the speed of the vehicle 12 based on the longitudinal acceleration command Aₓc. In one non-limiting embodiment, the one or more controllers 20 determine the longitudinal acceleration command A_{xC} based on a two-dimensional look-up table 54 that is either saved in memory or in a database in wireless communication with the one or more controllers 20. The two-dimensional table 54 provides a value of the longitudinal acceleration command A_{xC} of the vehicle 12 based on the allowed longitudinal acceleration A_{xA} and the current longitudinal vehicle velocity Vₓ. Alternatively, in another embodiment, the one or more controllers 20 calculate the longitudinal acceleration command A_{xC} of the vehicle 12 based on the allowed longitudinal acceleration A_{xA} and the current longitudinal vehicle velocity Vₓ as set forth in Equation 4 as:

$${A}_{xC} = {K}_{i} \int {A}_{xERR} + {K}_{P 1} {A}_{xERR} + min ( {K}_{P 2} {V}_{xERR} , {A}_{xA} ) \qquad Equation 4$$

where Kᵢ represents a control gain of an integration error, A_{xERR} represents an acceleration-based error term, K_{P1} represents a proportional control gain, K_{P2} represents a proportional gain, and V_{xERR} represents a velocity-based error term. The acceleration-based error term A_{xERR} represents the difference between an actual longitudinal acceleration Aₓ and a predicted longitudinal acceleration A_{xR}, and the velocity-based error term represents the difference between the current longitudinal vehicle velocity Vₓ and a requested longitudinal velocity V_{xREQ} of the vehicle 12.

As seen in Equation 4 above, the longitudinal acceleration command A_{xC} of the vehicle 12 includes an acceleration-based error component that is based on the acceleration-based error term (i.e., Kᵢ∫A_{xERR}+K_{P1}A_{xERR}) and a velocity-based error component that is based on the velocity-based error term (i.e., min(K_{P}2V_{xERR},A_{xA})). In one embodiment, the one or more controllers 20 limit the entire longitudinal acceleration command A_{xC} of the vehicle 12 (i.e., both the acceleration-based error component and the velocity-based error component). Alternatively, in another embodiment, the one or more controllers 20 limit the velocity-based error component of the longitudinal acceleration command A_{xC} of the vehicle 12. It is to be appreciated that Equation 4 above limits the velocity-based error component of the longitudinal acceleration command A_{xC} of the vehicle 12. Furthermore, the acceleration-based error term of the longitudinal acceleration command A_{xC} of the vehicle 12 accounts for external disturbances such as, for example, load changes and grade changes, which should not be reduced based on the lateral acceleration.

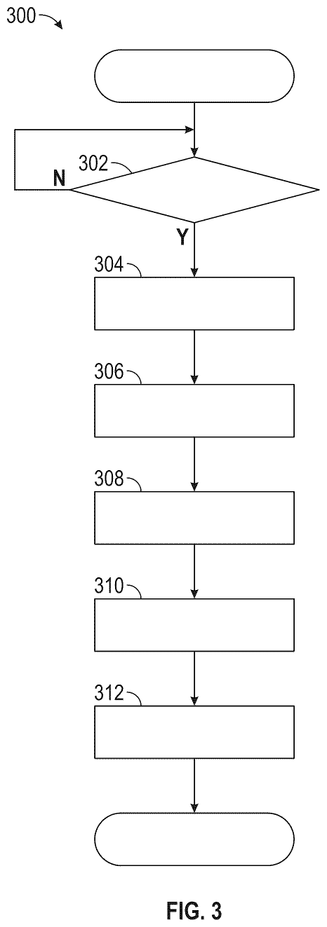

FIG. 3 is a process flow diagram illustrating a method 300 for determining the longitudinal acceleration command A_{xC} of the vehicle 12. Referring generally to FIGS. 1-3, the method 300 may begin at decision block 302. In decision block 302, the one or more controllers 20 continue to monitor the one or more systems 30 of the vehicle 12 until receiving the current longitudinal vehicle velocity Vₓ, the current lateral vehicle velocity V_{y}, the road wheel angle, and the autonomous acceleration command A_{xC}. The method 300 may then proceed to block 304.

In block 304, the one or more controllers 20 determine the predicted longitudinal velocity V_{xP} of the vehicle 12 based on the current longitudinal vehicle velocity Vₓ, the autonomous acceleration command A_{xC}, and the predicted time T_{P} as expressed in Equation 1 above. The method 300 may then proceed to block 306.

In block 306, the one or more controllers 20 determine the predicted lateral acceleration A_{yP} of the vehicle 12 based on the predicted longitudinal velocity V_{xP} of the vehicle 12. Specifically, the one or more controllers 20 determine the predicted lateral acceleration A_{yP} of the vehicle 12 by first determining the predicted yaw rate of the vehicle 12 based on the predicted longitudinal velocity V_{xP} of the vehicle 12, and then multiplying the predicted yaw rate of the vehicle 12 with the current longitudinal vehicle velocity Vₓ, or A_{yP}=*Vₓ. The method 300 may then proceed to block 308.

In block 308, the one or more controllers 20 determine the allowed longitudinal acceleration A_{xA} of the vehicle 12 based on the predicted lateral acceleration A_{yP} of the vehicle 12 and the current longitudinal vehicle velocity Vₓ. As mentioned above, in one non-limiting embodiment, the one or more controllers 20 determines the allowed longitudinal acceleration A_{xA} of the vehicle 12 based on the two-dimensional look-up table 50. Alternatively, in another embodiment, the allowed longitudinal acceleration A_{xA} of the vehicle 12 is the square root of a difference between a velocity-based constant Kᵥₓ and the predicted lateral acceleration A_{yP} squared, which is expressed in Equation 3 above. The method 300 may then proceed to block 310.

In block 310, the one or more controllers 20 determine the longitudinal acceleration command A_{xC} based on the allowed longitudinal acceleration A_{xA} and the current longitudinal vehicle velocity Vₓ. As mentioned above, in one embodiment the one or more controllers 20 determine the longitudinal acceleration command A_{xC} based on the two-dimensional look-up table 54 or, in another embodiment, the one or more controllers 20 calculate the longitudinal acceleration command A_{xC} of the vehicle 12 based on the allowed longitudinal acceleration A_{xA} and the current longitudinal vehicle velocity Vₓ as set forth in Equation 4 above. The method 300 may then proceed to block 312.

In block 312, the one or more controllers 20 may then instruct the prime mover 22 of the vehicle 12 to limit the speed of the vehicle 12 based on the longitudinal acceleration command A_{xC} as the vehicle 12 negotiates the curve 40 in the roadway 42 (FIG. 2). The method 300 may then terminate.

Referring generally to the figures, the disclosed motion control system provides various technical effects and benefits. Specifically, the disclosed motion control system provides an approach limiting the speed of the vehicle as the vehicle negotiates a curve in the roadway, thereby satisfying occupant comfort parameters. The disclosed motion control system also provides an approach to predict vehicle states and limits the longitudinal acceleration command of the vehicle based on the predicted vehicle states. The disclosed motion control system may be applied to vehicles of varying size and also accounts for the presence of a trailer.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A motion control system for a vehicle including a prime mover, the motion control system comprising:
one or more controllers in electronic communication with the prime mover, wherein the one or more controllers include one or more processors that execute instructions to:
receive a current longitudinal vehicle velocity and an autonomous acceleration command;
determine a predicted longitudinal velocity of the vehicle based on the current longitudinal vehicle velocity and the autonomous acceleration command;
determine a predicted lateral acceleration of the vehicle based on the predicted longitudinal velocity of the vehicle;
determine an allowed longitudinal acceleration of the vehicle based on the predicted lateral acceleration of the vehicle and the current longitudinal vehicle velocity;
determine a longitudinal acceleration command based on the allowed longitudinal acceleration and the current longitudinal vehicle velocity; and
instruct the prime mover of the vehicle to limit the speed of the vehicle based on the longitudinal acceleration command.

2. The motion control system of claim 1, wherein the one or more controllers determine the longitudinal acceleration command as:
$${A}_{xC} = {K}_{i} \int {A}_{xERR} + {K}_{P 1} {A}_{xERR} + min ( {K}_{P 2} {V}_{xERR} , {A}_{xA} )$$
wherein A_{xC} represents the longitudinal acceleration command, Kᵢ represents a control gain of an integration error, A_{xERR} represents an acceleration-based error term, K_{P1} represents a first proportional control gain, K_{P2} represents a proportional gain, A_{xA} represents the allowed longitudinal acceleration, and V_{xERR} represents a velocity-based error term.

3. The motion control system of claim 1, wherein the longitudinal acceleration command of the vehicle includes an acceleration-based error component that is based on an acceleration-based error term and a velocity-based error component that is based on a velocity-based error term.

4. The motion control system of claim 3, wherein the one or more controllers limit the velocity-based error component of the longitudinal acceleration command of the vehicle.

5. The motion control system of claim 1, wherein the one or more controllers determine the longitudinal acceleration command based on a two-dimensional look-up table.

6. The motion control system of claim 1, wherein determining the predicted lateral acceleration of the vehicle includes:
determining a predicted yaw rate of the vehicle based on the predicted longitudinal velocity of the vehicle; and
multiplying the predicted yaw rate of the vehicle with the current longitudinal vehicle velocity, wherein the derivative of a current lateral vehicle velocity is assumed to be zero.

7. The motion control system of claim 6, wherein the predicted yaw rate is determined as:
$$ψ = \frac{δ * {V}_{xP}}{L + {K}_{us} * {V}_{xP}^{2}}$$
wherein \dot{ψ} represents the predicted yaw rate, δ represents a predicted road wheel angle of the vehicle, L represents the wheelbase of the vehicle, Kᵤₛ represents an understeer coefficient, and V_{xP} represents the predicted longitudinal velocity.

8. The motion control system of claim 7, wherein the understeer coefficient accounts for vehicle weight as well as the presence of a trailer.

9. The motion control system of claim 1, wherein the one or more controllers determine the allowed longitudinal acceleration of the vehicle based on a two-dimensional look-up table that provides the allowed longitudinal acceleration of the vehicle based on the predicted lateral acceleration and the current longitudinal vehicle velocity.

10. The motion control system of claim 1, wherein the one or more controllers determine the allowed longitudinal acceleration of the vehicle as:
$${A}_{xA} = \sqrt{{K}_{vx} - {A}_{yP}^{2}}$$
wherein A_{xA} represents the allowed longitudinal acceleration of the vehicle, Kᵥₓ represents a velocity-based constant, and A_{yP} represents the predicted lateral acceleration.

11. The motion control system of claim 1, wherein the predicted longitudinal velocity is determined as:
$${V}_{xP} = {V}_{x} + {A}_{xC} {T}_{P}$$
wherein V_{xP} represents the predicted longitudinal velocity, Vₓ represents the current longitudinal vehicle velocity, A_{xC} represents the autonomous acceleration command A_{xC}, and T_{P} represents a predicted time.

12. The motion control system of claim 11, wherein the predicted time represents a calibration parameter determined based on a reaction time of a propulsion system of the vehicle.

13. The motion control system of claim 1, wherein the motion control system is an advanced driver assistance system (ADAS).

14. The motion control system of claim 1, wherein the motion control system is an adaptive cruise control system (ACC).

15. A method for limiting the speed of a vehicle by a motion control system, the method comprising:
receiving, by one or more controllers, a current longitudinal vehicle velocity and an autonomous acceleration command;
determining, by the one or more controllers, a predicted longitudinal velocity of the vehicle based on the current longitudinal vehicle velocity and the autonomous acceleration command;
determining a predicted lateral acceleration of the vehicle based on the predicted longitudinal velocity of the vehicle;
determining an allowed longitudinal acceleration of the vehicle based on the predicted lateral acceleration of the vehicle and the current longitudinal vehicle velocity;
determining a longitudinal acceleration command based on the allowed longitudinal acceleration and the current longitudinal vehicle velocity; and
instructing a prime mover of the vehicle to limit the speed of the vehicle based on the longitudinal acceleration command.

16. The method of claim 15, further comprising:
determining the longitudinal acceleration command as:
$${A}_{xC} = {K}_{i} \int {A}_{xERR} + {K}_{P 1} {A}_{xERR} + min ( {K}_{P 2} {V}_{xERR} , {A}_{xA} )$$
wherein A_{xC} represents the longitudinal acceleration command, Kᵢ represents a control gain of an integration error, A_{xERR} represents an acceleration-based error term, K_{P1} represents a first proportional control gain, K_{P2} represents a proportional gain, A_{xA} represents the allowed longitudinal acceleration, and V_{xERR} represents a velocity-based error term.

17. The method of claim 15, further comprising:
limiting a velocity-based error component of the longitudinal acceleration command of the vehicle.

18. The method of claim 15, further comprising:
determining the longitudinal acceleration command based on a two-dimensional look-up table.

19. The method of claim 15, further comprising determining the predicted lateral acceleration of the vehicle by:
determining a predicted yaw rate of the vehicle based on the predicted longitudinal velocity of the vehicle; and
multiplying the predicted yaw rate of the vehicle with the current longitudinal vehicle velocity, wherein the derivative of a current lateral vehicle velocity is assumed to be zero.

20. A motion control system for a vehicle including a prime mover, the motion control system comprising:
one or more controllers in electronic communication with the prime mover, wherein the one or more controllers include one or more processors that execute instructions to:
receive a current longitudinal vehicle velocity and an autonomous acceleration command;
determine a predicted longitudinal velocity of the vehicle based on the current longitudinal vehicle velocity and the autonomous acceleration command;
determine a predicted lateral acceleration of the vehicle based on the predicted longitudinal velocity of the vehicle;
determine an allowed longitudinal acceleration of the vehicle based on the predicted lateral acceleration of the vehicle and the current longitudinal vehicle velocity;
determine a longitudinal acceleration command based on the allowed longitudinal acceleration and the current longitudinal vehicle velocity, wherein the longitudinal acceleration command of the vehicle includes an acceleration-based error component that is based on an acceleration-based error term and a velocity-based error component that is based on a velocity-based error term;
limit the velocity-based error component of the longitudinal acceleration command of the vehicle; and
instruct the prime mover of the vehicle to limit the speed of the vehicle based on the longitudinal acceleration command.
